(19) United States
(12) Patent Application Publication
(10) Pub. No.: US 2026/0332900 A1
(43) Pub. Date: Oct. 22, 2026

(54) IMAGING APPARATUS AND DRIVING METHOD

(71) Applicant: Nuvoton Technology Corporation Japan, Kyoto (JP)

(72) Inventors: Takahiro MUROSHIMA, Kyoto (JP); Yasuhiro KOSAKA, Kyoto (JP); Toru YAMADA, Kyoto (JP)

(21) Appl. No.: 19/702,532

(22) Filed: Jun. 9, 2026

Related U.S. Application Data
(63) Continuation of application No. PCT/JP2024/043804, filed on Dec. 11, 2024.
(60) Provisional application No. 63/609,653, filed on Dec. 13, 2023.

(51) Int. Cl. H04N 23/73; H04N 25/705; H04N 25/76

(52) U.S. Cl. CPC H04N 23/73; H04N 25/705; H04N 25/7795

(57) ABSTRACT

An imaging apparatus includes pixels each including a photoelectric converter that converts incident light into charge, and a drive controller. The drive controller exposes the pixels to cause the pixels to generate one or more types of first signals for representing a first signal value corresponding to the charge converted by the photoelectric converter during the period of a first exposure pulse, and one or more types of second signals for representing a second signal value corresponding to the charge converted by the photoelectric converter during the period of a second exposure pulse. The second exposure pulse starts with a predetermined time difference relative to the start of the first exposure pulse. The pulse widths of the first exposure pulse and the second exposure pulse are equal to each other, and are each shorter than the pulse width of the light emission pulse.

### CROSS REFERENCE TO RELATED APPLICATIONS

This is a continuation application of PCT International Patent Application No. PCT/JP2024/043804 filed on Dec. 11, 2024, designating the United States of America, which is based on and claims priority of U.S. Provisional Patent Application No. 63/609,653 filed on Dec. 13, 2023. The entire disclosures of the above-identified applications, including the specifications, drawings and claims are incorporated herein by reference in their entirety.

### FIELD

The present disclosure relates to an imaging apparatus and a method for driving the imaging apparatus.

### BACKGROUND

Imaging apparatuses that generate distance images using an indirect time-of-flight (TOF) method are conventionally known. In the generation of a distance image using an indirect TOF method, for instance, pixels receive reflected light from a target object in response to irradiation light emitted by a light source, and a distance image is generated based on reflected light-based signals which are output from the pixels.

Multipath light is an issue that reduces the distance measurement accuracy of an indirect TOF method. Compared with reflected light via a direct path, where primary light from a light source directly hits a target object and returns, multipath light has the feature that secondary or higher-order light that first hits at least one time and diffuses on an object other than the target object, and then reaches the target object before returning to the sensor. Accordingly, when multipath light occurs, the distance to the target object is calculated as greater than the actual distance. In particular, in distance measurement in closed spaces, such as for endoscopic applications, multipath light increases, leading to larger distance measurement errors.

To mitigate the effects of multipath light, Patent Literature (PTL) 1 discloses a distance measuring apparatus that selects a charge pair that is less susceptible to multipath light among charge pairs corresponding to exposure control signal pairs each having a phase difference that matches the pulse width of the pulsed light.

### CITATION LIST

### Patent Literature

PTL 1: International Publication No. WO2023/199804

### SUMMARY

### Technical Problem

In the technique disclosed in PTL 1, it is not possible to reduce the effects of multipath light on signal charges (signal values) themselves obtained by exposures performed in accordance with exposure control signals. Accordingly, in the technique disclosed in PTL 1, to mitigate the effects of multipath light, the number of exposures necessary to calculate the distance is increased, and computation for calculating the distance from signal charges obtained through exposures becomes complex.

In view of this, the present disclosure provides an imaging apparatus and so forth that can obtain a signal value with a reduced effect of multipath light.

### Solution to Problem

An imaging apparatus according to one aspect of the present disclosure includes: a plurality of pixels arranged in a matrix, the plurality of pixels each including a photoelectric converter that converts incident light into charge, and generating a signal based on the charge; and a drive controller that exposes, in each of one or more frames, each of the plurality of pixels at a timing referenced to emission of pulsed light from a light source toward a target object, in which the drive controller exposes the plurality of pixels to cause the plurality of pixels to generate one or more types of first signals and one or more types of second signals, the one or more types of first signals being for representing a first signal value corresponding to the charge converted by the photoelectric converter during a first period that starts at a timing referenced to the emission of the pulsed light from the light source, the one or more types of second signals being for representing a second signal value corresponding to the charge converted by the photoelectric converter during a second period that starts at a timing referenced to the emission of the pulsed light from the light source, the second period starts with a predetermined time difference relative to a start of the first period, with the emission of the pulsed light from the light source used as a reference, and a length of the first period and a length of the second period are equal to each other, and are each shorter than a pulse width of the pulsed light.

A driving method according to another aspect of the present disclosure is a method for driving an imaging apparatus that includes a plurality of pixels arranged in a matrix, the plurality of pixels each including a photoelectric converter that converts incident light into charge, and generating a signal based on the charge. The method includes: exposing, in each of one or more frames, each of the plurality of pixels at a timing referenced to emission of pulsed light from a light source toward a target object, in which in the exposing of each of the plurality of pixels, the plurality of pixels are exposed to cause the plurality of pixels to generate one or more types of first signals and one or more types of second signals, the one or more types of first signals being for representing a first signal value corresponding to the charge converted by the photoelectric converter during a first period that starts at a timing referenced to the emission of the pulsed light from the light source, the one or more types of second signals being for representing a second signal value corresponding to the charge converted by the photoelectric converter during a second period that starts at a timing referenced to the emission of the pulsed light from the light source, the second period starts with a predetermined time difference relative to a start of the first period, and a length of the first period and a length of the second period are equal to each other, and are each shorter than a pulse width of the pulsed light.

### Advantageous Effects

The present disclosure can provide an imaging apparatus and so forth that can obtain a signal value with a reduced effect of multipath light.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a time chart illustrating effects of multipath light.

FIG. 2 is a functional block diagram illustrating an example of a configuration of an imaging apparatus according to an embodiment.

FIG. 3 is a circuit diagram illustrating an example of a circuit configuration of a pixel according to the embodiment.

FIG. 4 is a time chart illustrating a first example of a method for driving the imaging apparatus according to the embodiment.

FIG. 5 is a time chart illustrating another first example of the method for driving the imaging apparatus according to the embodiment.

FIG. 6 is a time chart illustrating a second example of the method for driving the imaging apparatus according to the embodiment.

FIG. 7 is a time chart illustrating another second example of the method for driving the imaging apparatus according to the embodiment.

FIG. 8 is a time chart illustrating a third example of the method for driving the imaging apparatus according to the embodiment.

FIG. 9 is an enlarged illustration of a first exposure pulse and a second exposure pulse in FIG. 8.

FIG. 10 illustrates a signal value obtained in the third example of the method for driving the imaging apparatus according to the embodiment.

FIG. 11 is a time chart illustrating a fourth example of the method for driving the imaging apparatus according to the embodiment.

FIG. 12 is a functional block diagram illustrating an example of a configuration of an imaging apparatus according to a variation of the embodiment.

### DESCRIPTION OF EMBODIMENT

### (Circumstances Leading to One Aspect of the Present Disclosure)

Before an embodiment of the present disclosure is described specifically, problems and the like found by the inventors of the present application are described.

As described above, in the generation of a distance image using an indirect TOF method, the distance to a target object can be calculated as greater than the actual distance due to the effects of multipath light.

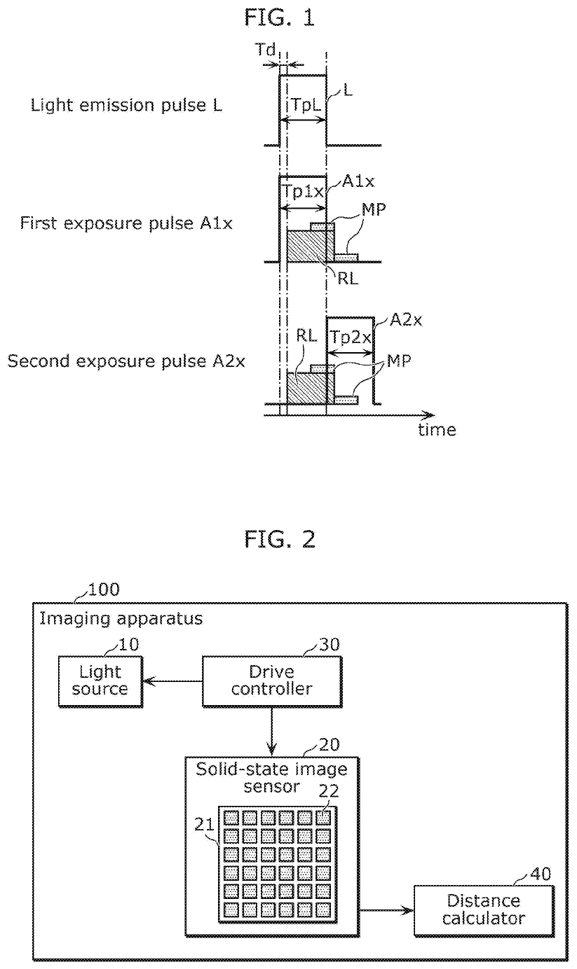

FIG. 1 is a time chart illustrating effects of multipath light. FIG. 1 illustrates an example where a pixel is exposed according to first exposure pulse A1x and second exposure pulse A2x to reflected light RL from a target object, which is pulsed light emitted from a light source based on light emission pulse L. Moreover, FIG. 1 illustrates a conventional method for driving an imaging apparatus. In the example illustrated in FIG. 1, pulse width TpL of light emission pulse L, pulse width Tp1x of first exposure pulse A1x, and pulse width Tp2x of second exposure pulse A2x are the same. Moreover, second exposure pulse A2x starts with a delay of a time difference of pulse width TpL relative to the start of first exposure pulse A1x. Reflected light RL via a direct path from a target object is incident on a pixel with a delay of time Td relative to light emission pulse L.

As illustrated in FIG. 1, a pixel of the imaging apparatus is exposed based on first exposure pulse A1x and second exposure pulse A2x, and generates charge based on reflected light RL incident on the pixel. However, during the exposure of the pixel, multipath light MP is also incident on the pixel with an additional delay compared to reflected light RL, and therefore, charge based on multipath light MP is also generated in the pixel. Since multipath light MP is a component that is incident on the pixel with an additional delay compared to reflected light RL, it results in an error in distance measurement for the target object.

In view of this, to obtain a signal value with a reduced effect of multipath light, the inventors of the present application focused on a method for shortening the pulse width of pulsed light emitted toward a target object and reducing an exposure period during which a pixel is exposed. By shortening the pulse width of the pulsed light and reducing the exposure period, the pixel is less likely to receive multipath light during the exposure, and can obtain a signal value with a reduced effect of the multipath light. For instance, it is known from the example illustrated in FIG. 1 that charge generated based on multipath light MP incident on a pixel during the exposure is reduced by shortening pulse width TpL of pulsed light and reducing the exposure period. Accordingly, it is possible to obtain a signal value with a reduced effect of the multipath light.

Meanwhile, the method has the issue that due to insufficient response of the light source that emits pulsed light, it is difficult to shorten the pulse width of the pulsed light for the amount that can sufficiently reduce effects of multipath light.

In view of this, the inventors of the present application focused on the necessity of obtaining a signal value with a reduced effect of multipath light without shortening the pulse width of pulsed light, which, in turn, enabled them to obtain one aspect of the present disclosure.

Hereinafter, an embodiment of the present disclosure is described in detail with reference to the drawings.

It should be noted that the embodiment described below indicates a comprehensive or specific example. The numerical values, shapes, elements, arrangement and connection of the elements, steps, order of steps, and so forth indicated in the embodiment described below are merely examples, and do not intend to limit the present disclosure. Moreover, among the elements described in the embodiment below, those not recited in the independent claims are described as optional elements. Moreover, the figures are schematic illustrations and are not necessarily precise depictions. Moreover, in the figures, substantially the same elements are assigned the same reference signs, and overlapping explanations are omitted or simplified.

Moreover, in the specification, terms indicating relationships between elements, such as vertical, horizontal, or matching, terms describing the shapes of elements, such as circular or rectangular, and numerical ranges should not be construed as limited to their strict interpretation. Rather, they are intended to encompass substantially equivalent ranges, including variations of, for example, approximately a few percent.

Moreover, in this specification, ordinal numbers such as “first” and “second” are used for the purpose of distinguishing between similar elements to avoid confusion, and do not indicate the quantity or order of the elements unless explicitly stated otherwise.

Moreover, in the specification, “connection” between elements means electrical connection unless otherwise noted.

### EMBODIMENT

Hereinafter, an imaging apparatus according to an embodiment is described.

### Configuration

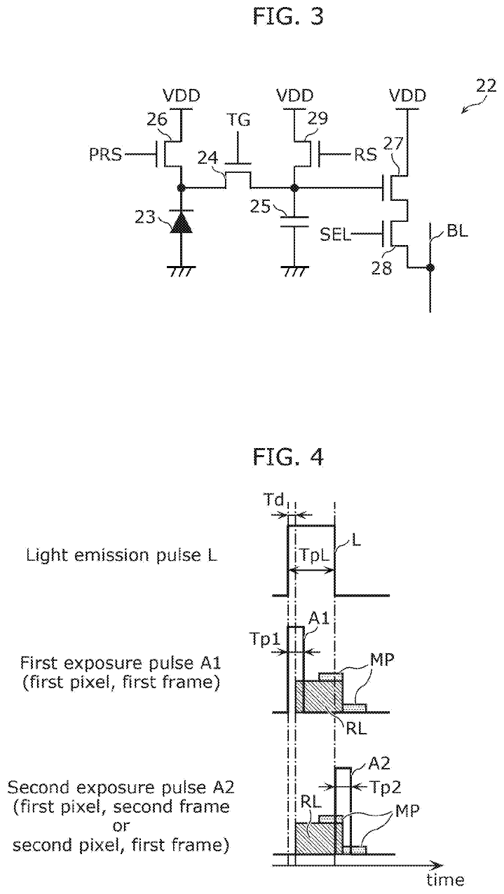

First, a configuration of an imaging apparatus according to an embodiment is described. FIG. 2 is a functional block diagram illustrating an example of a configuration of imaging apparatus 100 according to the embodiment. FIG. 3 is a circuit diagram illustrating an example of a circuit configuration of pixel 22 according to the embodiment.

As illustrated in FIG. 2, imaging apparatus 100 includes light source 10, solid-state image sensor 20, drive controller 30, and distance calculator 40. Imaging apparatus 100 is, for example, an imaging apparatus that generates a distance image of a target object. Although uses of imaging apparatus 100 are not particularly limited, imaging apparatus 100 may be used in an endoscopy system. As described later, imaging apparatus 100 can obtain a signal value with a reduced effect of multipath light, and is particularly useful when a distance image is captured in a closed space as for an endoscopy system.

Light source 10 emits pulsed light for irradiating the target object, in accordance with the timing indicated by a light emission pulse included in an input light emission control signal. Light source 10 includes, for example, a light-emitting element, such as a light-emitting diode or a laser element, that emits visible light or infrared light, as well as an optical system onto which the light from the light-emitting element is incident and which controls distribution of the light from the light-emitting element.

Solid-state image sensor 20 is, for example, a charge-coupled device (CCD) sensor or a complementary metal-oxide-semiconductor (CMOS) sensor. Solid-state image sensor 20 is, for example, a one-chip element. Solid-state image sensor 20 includes pixel array 21 where pixels 22 are arranged in a matrix. For instance, pixels 22 have the same configuration. The number of pixels 22 illustrated in FIG. 2 is a non-limiting example.

Pixel 22 generates a signal based on incident light. Specifically, pixel 22 converts incident light into charge, and generates a signal based on the converted charge.

As illustrated in FIG. 3, pixel 22 includes photoelectric converter 23, transfer transistor 24, charge storage 25, charge drain transistor 26, source follower transistor 27, select transistor 28, and reset transistor 29. Each of transfer transistor 24, charge storage 25, charge drain transistor 26, source follower transistor 27, select transistor 28, and reset transistor 29 is, for example, an N-channel metal-oxide-semiconductor FET (MOSFET). It should be noted that the circuit configuration of pixel 22 illustrated in FIG. 3 is a mere example and can be changed as necessary.

Photoelectric converter 23 generates charge by converting light incident on pixel 22 into charge. The light incident on pixel 22 includes, for example, the reflected light from the target object, which is the pulsed light emitted from light source 10. Photoelectric converter 23 includes, for example, a photoelectric conversion device, such as a photodiode. Photoelectric converter 23 is connected to one of the source or drain of transfer transistor 24 and connected to one of the source or drain of charge drain transistor 26.

Transfer transistor 24 transfers the charge converted by photoelectric converter 23 from photoelectric converter 23 to charge storage 25. The other of the source or drain of transfer transistor 24 is connected to charge storage 25. Transfer control signal TG that controls ON and OFF of transfer transistor 24 is applied to the gate of transfer transistor 24.

Charge storage 25 stores the charge converted by photoelectric converter 23 and transferred by transfer transistor 24. Specifically, the charge converted by photoelectric converter 23 during the exposure of pixel 22 is stored in charge storage 25. Charge storage 25 is, for example, an impurity region which is formed in a semiconductor substrate and which cannot enter a floating state. Moreover, charge storage 25 may include interconnect capacitance.

Charge drain transistor 26 drains the charge converted by photoelectric converter 23 to the outside of pixel 22. Power supply voltage VDD is applied to the other of the source or drain of charge drain transistor 26. Charge drain control signal PRS that controls ON and OFF of charge drain transistor 26 is applied to the gate of charge drain transistor 26.

Source follower transistor 27 outputs a signal corresponding to the electric potential of charge storage 25. That is, source follower transistor 27 reads out the charge stored in charge storage 25. The gate of source follower transistor 27 is connected to charge storage 25. Power supply voltage VDD is applied to one of the source or drain of source follower transistor 27. The other of the source or drain of source follower transistor 27 is connected to one of the source or drain of select transistor 28, and a signal corresponding to the electric potential of charge storage 25 is output to bit line BL via select transistor 28. Source follower transistor 27 as well as a current source connected to bit line BL form a source follower circuit.

The other of the source or drain of select transistor 28 is connected to bit line BL, which is a signal line to which a signal from pixel 22 is output. Select control signal SEL that controls ON and OFF of select transistor 28 is applied to the gate of select transistor 28. When select transistor 28 is turned on, source follower transistor 27 reads out the charge. The signal from pixel 22 output to bit line BL is, for example, converted into a digital signal by a not-illustrated AD conversion circuit, and then input into distance calculator 40.

Reset transistor 29 resets the electric potential of charge storage 25. One of the source or drain of reset transistor 29 is connected to charge storage 25. Power supply voltage VDD is applied to the other of the source or drain of reset transistor 29. Reset control signal RS that controls ON and OFF of reset transistor 29 is applied to the gate of reset transistor 29. When reset transistor 29 is turned on, the electric potential of charge storage 25 is reset to power supply voltage VDD.

For instance, drive controller 30 generates transfer control signal TG, charge drain control signal PRS, select control signal SEL, and reset control signal RS.

FIG. 2 is referenced again. Drive controller 30 controls the driving of light source 10 and solid-state image sensor 20. Drive controller 30 outputs, to light source 10, a light emission control signal for causing light source 10 to emit pulsed light. The light emission control signal includes, for example, a light emission pulse. The light emission pulse is a pulse that instructs light source 10 to emit light, and indicates a period during which light source 10 emits pulsed light. Moreover, drive controller 30 outputs, to each pixel 22, an exposure control signal for exposing each pixel 22 during a predetermined period. The exposure control signal includes, for example, an exposure pulse. The exposure pulse is a pulse that instructs pixel 22 to be exposed, and indicates the exposure period of pixel 22.

In accordance with the exposure control signal, drive controller 30 exposes, in each of one or more frames, each of pixels 22 at a timing referenced to the emission of pulsed light from light source 10 toward the target object. Although details are described later, drive controller 30 exposes pixels 22 to cause pixels 22 to generate one or more types of first signals and one or more types of second signals. The one or more types of first signals are signals for representing a first signal value corresponding to charge converted by photoelectric converter 23 during a first period that starts at a timing referenced to the emission of pulsed light from light source 10 toward the target object. The one or more types of second signals are signals for representing a second signal value corresponding to charge converted by photoelectric converter 23 during a second period that starts at a timing referenced to the emission of pulsed light from light source 10 toward the target object.

Here, with the emission of the pulsed light from light source 10 used as a reference, the second period starts with a predetermined time difference relative to the start of the first period. As an example, the predetermined time difference is equal to the pulse width of the pulsed light. As another example, the predetermined time difference is shorter than each of the lengths of the first period and the second period. Moreover, the lengths of the first period and second period are equal to each other, and are each shorter than the pulse width of the pulsed light emitted from light source 10.

It should be noted that in the specification, the period during which pixel 22 is exposed (also referred to as exposure period) means a period during which charge used for signal readout from pixel 22 is stored. Accordingly, even if light is incident on pixel 22 and charge is generated in photoelectric converter 23, if for example the signal is drained and thus the charge is not used for signal readout, this is non-exposure. For instance, exposure indicates a state where charge drain transistor 26 is turned off and charge generated in photoelectric converter 23 is not drained and where transfer transistor 24 is turned on and charge is transferred from photoelectric converter 23 to charge storage 25. It should be noted that during the exposure period of pixel 22, provided that charge generated in photoelectric converter 23 is transferred to charge storage 25 by the end of the exposure period, transfer transistor 24 need not always be in an ON state during the exposure period.

Based on signals output from pixels 22 of solid-state image sensor 20, distance calculator 40 calculates the distances to the target object irradiated with the pulsed light from light source 10. For instance, distance calculator 40 calculates the distances to the target object based on the one or more types of first signals and the one or more types of second signals described above. For instance, distance calculator 40 generates a distance image indicating the calculated distances, and outputs the distance image to an external destination outside imaging apparatus 100.

Drive controller 30 and distance calculator 40 are, for example, processing circuits implemented by memory storing a program, a processor that executes the program, and so forth. It should be noted that although illustrated as separate blocks in the block diagram, all or part of drive controller 30 and distance calculator 40 may be configured using the same memory and the same processor. Moreover, drive controller 30 and distance calculator 40 may be dedicated logic circuits that perform predetermined processing. Moreover, at least one of drive controller 30 or distance calculator 40 may be provided inside solid-state image sensor 20.

### [Driving Method]

Hereinafter, a method for driving imaging apparatus 100 according to the embodiment is described.

### (1) First Example of Driving Method

First, a first example of the method for driving imaging apparatus 100 according to the embodiment is described. FIG. 4 is a time chart illustrating the first example of the method for driving imaging apparatus 100 according to the embodiment.

Regarding “Light emission pulse L” in FIG. 4, light emission pulse L in a light emission control signal output from drive controller 30 to light source 10 is illustrated. Based on light emission pulse L, light source 10 emits pulsed light during the period from the rising edge to the falling edge of light emission pulse L. Accordingly, pulse width TpL of light emission pulse L can be referred to as the pulse width of the pulsed light. It should be noted that in the example illustrated in FIG. 4, light emission pulse L is a rectangular wave, but it may be a triangular wave.

Regarding “First exposure pulse A1” in FIG. 4, first exposure pulse A1 output from drive controller 30 to pixel 22 is illustrated. Specifically, first exposure pulse A1 is applied to the gate of transfer transistor 24 as transfer control signal TG. Thus, transfer transistor 24 is turned on during the period of first exposure pulse A1, and charge converted by photoelectric converter 23 is stored in charge storage 25.

Regarding “Second exposure pulse A2” in FIG. 4, second exposure pulse A2 output from drive controller 30 to pixel 22 is illustrated. Specifically, second exposure pulse A2 is applied to the gate of transfer transistor 24 as transfer control signal TG. Thus, transfer transistor 24 is turned on during the period of second exposure pulse A2, and charge converted by photoelectric converter 23 is stored in charge storage 25.

Although not illustrated, charge drain transistor 26 switches from OFF to ON when each of the exposure pulses described above starts.

Moreover, for each of “First exposure pulse A1” and “Second exposure pulse A2” in FIG. 4, a period when reflected light RL from the target object via a direct path, which is the pulsed light emitted from light source 10, is incident on pixel 22, is illustrated, and a period when multipath light MP is incident on pixel 22, is illustrated.

Moreover, in the example illustrated in FIG. 4, in a first frame, first exposure pulse A1 is output from drive controller 30 to a first pixel, which is one of pixels 22. Second exposure pulse A2 is output from drive controller 30 to pixel 22 in a frame different from the frame for first exposure pulse A1 or in the same frame as first exposure pulse A1.

If second exposure pulse A2 is output in a frame different from the frame for first exposure pulse A1, second exposure pulse A2 is output from drive controller 30 to the above first pixel in a second frame.

If second exposure pulse A2 is output in the same frame as first exposure pulse A1, second exposure pulse A2 is output from drive controller 30 to a second pixel, which is another pixel of pixels 22, in the first frame.

Here, the first frame and the second frame are, for example, continuous frames. Either the first frame or the second frame may come first. Moreover, the first pixel and the second pixel are, for example, pixels adjacent to one another. Pixels 22 may include first pixels and second pixels. For instance, pixels 22 are arranged such that the first pixels and the second pixels are alternately disposed at least in one of a row direction or a column direction.

FIG. 4 illustrates one light emission pulse L, one first exposure pulse A1, and one second exposure pulse A2. Drive controller 30 may repeatedly output each of light emission pulse L, first exposure pulse A1, and second exposure pulse A2 a plurality of times in one frame.

It should be noted that when pixel 22 includes two transfer transistors 24 and two charge storages 25, drive controller 30 can output first exposure pulse A1 and second exposure pulse A2 to one pixel 22 in the same frame.

As illustrated in FIG. 4, drive controller 30 outputs light emission pulse L to light source 10. By doing so, light source 10 emits pulsed light irradiating the target object during the period of light emission pulse L. Depending on the distance to the target object, reflected light RL via a direct path, which is the pulsed light reflected off the target object, is incident on pixel 22 with a delay of time Td relative to the emission of the pulsed light from light source 10. Moreover, multipath light MP is incident on pixel 22 with an additional delay compared to reflected light RL.

Moreover, drive controller 30 outputs first exposure pulse A1 to pixel 22. By doing so, drive controller 30 exposes pixel 22 during the period of first exposure pulse A1 to cause pixel 22 to generate a first exposure signal that is based on charge generated during the period. The first exposure signal is a first signal representing a first signal value corresponding to the charge converted by photoelectric converter 23 during the period of first exposure pulse A1. The period of first exposure pulse A1 is an example of a first period, and pulse width Tp1 of first exposure pulse A1 is an example of the length of the first period.

Moreover, drive controller 30 outputs second exposure pulse A2 to pixel 22. By doing so, drive controller 30 exposes pixel 22 during the period of second exposure pulse A2 to cause pixel 22 to generate a second exposure signal that is based on charge generated during the period. The second exposure signal is a second signal representing a second signal value corresponding to the charge converted by photoelectric converter 23 during the period of second exposure pulse A2. The period of second exposure pulse A2 is an example of a second period, and pulse width Tp2 of second exposure pulse A2 is an example of the length of the second period.

Each of first exposure pulse A1 and second exposure pulse A2 starts at a timing referenced to light emission pulse L. Pulse width Tp1 of first exposure pulse A1 and pulse width Tp2 of second exposure pulse A2 are equal to each other, and are each shorter than pulse width TpL of light emission pulse L. For example, each of pulse width Tp1 and pulse width Tp2 is less than or equal to 0.5 times pulse width TpL. Although the lower limits of pulse width Tp1 and pulse width Tp2 are not particularly limited as long as the necessary distance measurement range can be ensured, each of pulse width Tp1 and pulse width Tp2 may be at least 0.01 or 0.1 times pulse width TpL.

In the example illustrated in FIG. 4, first exposure pulse A1 starts simultaneously with the start of light emission pulse L. Moreover, with light emission pulse L used as a reference, second exposure pulse A2 starts with a time difference of pulse width TpL of light emission pulse L relative to the start of first exposure pulse A1. More specifically, with light emission pulse L used as a reference, second exposure pulse A2 starts with a delay of pulse width TpL of light emission pulse L relative to the start of first exposure pulse A1. It should be noted that drive controller 30 may output one or more other exposure pulses to pixel 22 after second exposure pulse A2. Exposure pulses including first exposure pulse A1 and second exposure pulse A2 in this case each start with a time lag of pulse width TpL. Thus, the distance measurement range of imaging apparatus 100 can be extended.

Distance calculator 40 calculates the distance to the target object based on the first exposure signal and the second exposure signal generated by one or more pixels 22. Since first exposure pulse A1 and second exposure pulse A2 have a phase difference of pulse width TpL of light emission pulse L, signal components corresponding to reflected light RL are distributed into the first exposure signal and the second exposure signal according to time Td correlated with the distance to the target object. That is, the magnitudes of the first signal value and the second signal value are in a ratio corresponding to time Td, which is the delay time of reflected light RL relative to light emission pulse L. Accordingly, when the first signal value represented by the first exposure signal is defined as a1, the second signal value represented by the second exposure signal is defined as a2, and the velocity of light is defined as c, distance Z to the target object is calculated by the following Expression (1). It should be noted that since Tp1=Tp2, Tp1 may be replaced with Tp2 in the following Expression (1).

$$\begin{matrix}[ Math . 1 ] & \\ Z = \frac{c \times Td}{2} = \frac{c}{2} \times \frac{a 1}{a 1 + a 2} Tp 1 & ( 1 )\end{matrix}$$

In the example illustrated in FIG. 4, pulse width Tp1 of first exposure pulse A1 is shorter than pulse width TpL of light emission pulse L, and first exposure pulse A1 ends by the time multipath light MP is incident on pixel 22. That is, first signal value a1 does not include components of multipath light MP. Moreover, pulse width Tp2 of second exposure pulse A2 is shorter than pulse width TpL of light emission pulse L. Accordingly, although second signal value a2 includes components of multipath light MP, it is possible to reduce the components of multipath light MP in second signal value a2. For instance, in a conventional example as illustrated in FIG. 1, all rays of multipath light MP that arrive after reflected light RL is no longer incident on the pixel are incident on the pixel during the exposure. Meanwhile, in the example illustrated in FIG. 4, only some rays of multipath light MP that arrive after reflected light RL is no longer incident are incident on pixel 22 during the exposure. In this way, by making pulse width Tp1 and pulse width Tp2 shorter than pulse width TpL, it is possible to reduce components of multipath light MP in first signal value a1 and second signal value a2. Accordingly, imaging apparatus 100 can obtain signal values with a reduced effect of multipath light MP. Moreover, because of the reduction in the effect of multipath light MP, imaging apparatus 100 can improve the accuracy of the distance calculated by distance calculator 40.

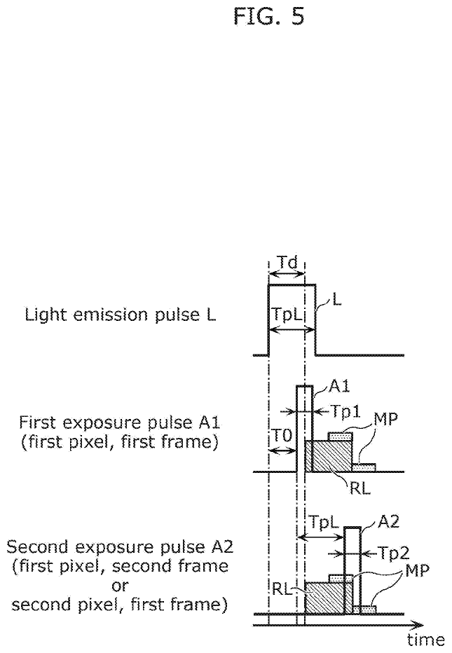

It should be noted that although it is a non-limiting example, FIG. 4 illustrates that first exposure pulse A1 starts simultaneously with the start of light emission pulse L. FIG. 5 is a time chart illustrating another first example of the method for driving imaging apparatus 100 according to the embodiment. Explanations for matters indicated by “Light emission pulse L”, “First exposure pulse A1”, and “Second exposure pulse A2” in FIG. 5 are the same as in FIG. 4. In the example of the driving method illustrated in FIG. 5, the time difference between the starts of first exposure pulse A1 and second exposure pulse A2 remains unchanged. However, a difference is found in that first exposure pulse A1 and second exposure pulse A2 are delayed in start relative to the example of the driving method illustrated in FIG. 4.

In the example illustrated in FIG. 5, first exposure pulse A1 starts with a delay of time TO relative to the start of light emission pulse L. Moreover, with light emission pulse L used as a reference, second exposure pulse A2 starts with a delay of pulse width TpL relative to the start of first exposure pulse A1. Accordingly, even when there is a large distance to the target object and time Td is long, it is possible to distribute signal components corresponding to reflected light RL into the first exposure signal and the second exposure signal. Distance calculator 40 calculates distance Z by adding C×T0/2 to the above Expression (1).

### (2) Second Example of Driving Method

Next, a second example of the method for driving imaging apparatus 100 according to the embodiment is described. Explanations for the second example below focus on the differences from the first example above, and explanations for common points are omitted or simplified.

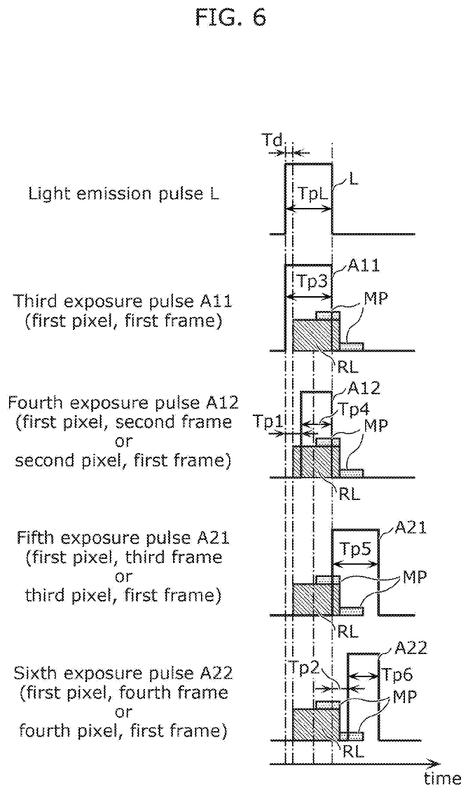

FIG. 6 is a time chart illustrating the second example of the method for driving imaging apparatus 100 according to the embodiment. Explanations for matters indicated by “Light emission pulse L” in FIG. 6 are the same as in FIG. 4.

Regarding “Third exposure pulse A11” in FIG. 6, third exposure pulse A11 output from drive controller 30 to pixel 22 is illustrated. Specifically, third exposure pulse A11 is applied to the gate of transfer transistor 24 as transfer control signal TG. By doing so, transfer transistor 24 is turned on during the period of third exposure pulse A11, and charge converted by photoelectric converter 23 is stored in charge storage 25.

Regarding “Fourth exposure pulse A12” in FIG. 6, fourth exposure pulse A12 output from drive controller 30 to pixel 22 is illustrated. Specifically, fourth exposure pulse A12 is applied to the gate of transfer transistor 24 as transfer control signal TG. By doing so, transfer transistor 24 is turned on during the period of fourth exposure pulse A12, and charge converted by photoelectric converter 23 is stored in charge storage 25.

Regarding “Fifth exposure pulse A21” in FIG. 6, fifth exposure pulse A21 output from drive controller 30 to pixel 22 is illustrated. Specifically, fifth exposure pulse A21 is applied to the gate of transfer transistor 24 as transfer control signal TG. By doing so, transfer transistor 24 is turned on during the period of fifth exposure pulse A21, and charge converted by photoelectric converter 23 is stored in charge storage 25.

Regarding “Sixth exposure pulse A22” in FIG. 6, sixth exposure pulse A22 output from drive controller 30 to pixel 22 is illustrated. Specifically, sixth exposure pulse A22 is applied to the gate of transfer transistor 24 as transfer control signal TG. By doing so, transfer transistor 24 is turned on during the period of sixth exposure pulse A22, and charge converted by photoelectric converter 23 is stored in charge storage 25.

Although not illustrated, charge drain transistor 26 switches from OFF to ON when each of the exposure pulses described above starts.

Moreover, as in FIG. 4, a period when reflected light RL from the target object via a direct path, which is the pulsed light emitted from light source 10, is incident on pixel 22 and a period when multipath light MP is incident on pixel 22, are illustrated for each of “Third exposure pulse A11”, “Fourth exposure pulse A12”, “Fifth exposure pulse A21”, and “Sixth exposure pulse A22” in FIG. 6.

Moreover, in the example illustrated in FIG. 6, third exposure pulse A11 is output from drive controller 30 to a first pixel, which is one of pixels 22, in a first frame. Third exposure pulse A11, fourth exposure pulse A12, fifth exposure pulse A21, and sixth exposure pulse A22 are output from drive controller 30 to pixel 22 in different frames or in the same frame.

When each of third exposure pulse A11, fourth exposure pulse A12, fifth exposure pulse A21, and sixth exposure pulse A22 is output in a different frame, fourth exposure pulse A12 is output from drive controller 30 to the above first pixel in a second frame. Moreover, in this case, fifth exposure pulse A21 is output from drive controller 30 to the above first pixel in a third frame. Moreover, in this case, sixth exposure pulse A22 is output from drive controller 30 to the above first pixel in a fourth frame.

When third exposure pulse A11, fourth exposure pulse A12, fifth exposure pulse A21, and sixth exposure pulse A22 are output in the same frame, fourth exposure pulse A12 is output from drive controller 30 to a second pixel, which is another pixel of pixels 22, in the first frame. Moreover, in this case, fifth exposure pulse A21 is output from drive controller 30 to a third pixel, which is yet another pixel of pixels 22, in the first frame. Moreover, in this case, sixth exposure pulse A22 is output from drive controller 30 to a fourth pixel, which is yet another pixel of pixels 22, in the first frame.

The first frame, second frame, third frame, and fourth frame are, for example, continuous frames. The order of the first frame, second frame, third frame, and fourth frame is not particularly limited. Moreover, the first pixel, second pixel, third pixel, and fourth pixel are, for example, pixels adjacent to one other. Pixels 22 may include first pixels, second pixels, third pixels, and fourth pixels. For instance, pixels 22 are arranged in an array where blocks each including four pixels 22 composed of the first pixel, second pixel, third pixel, and fourth pixel which are adjacent to one other are arranged in a row direction and in a column direction.

It should be noted that two pulses of third exposure pulse A11, fourth exposure pulse A12, fifth exposure pulse A21, and sixth exposure pulse A22 may be output to two different pixels 22 in the same frame, and the remaining two pulses may be output to those two pixels 22 in another identical frame. Moreover, if pixel 22 includes two transfer transistors 24 and two charge storages 25, drive controller 30 can make two pairs from third exposure pulse A11, fourth exposure pulse A12, fifth exposure pulse A21, and sixth exposure pulse A22, and divide the two pairs into the respective two frames in which the pairs will be output to one pixel 22.

FIG. 6 illustrates one light emission pulse L, one third exposure pulse A11, one fourth exposure pulse A12, one fifth exposure pulse A21, and one sixth exposure pulse A22. Drive controller 30 may repeatedly output each of light emission pulse L, third exposure pulse A11, fourth exposure pulse A12, fifth exposure pulse A21, and sixth exposure pulse A22 a plurality of times in one frame.

As illustrated in FIG. 6, drive controller 30 outputs third exposure pulse A11 to pixel 22. By doing so, drive controller 30 exposes pixel 22 during the period of third exposure pulse A11 to cause pixel 22 to generate a third exposure signal that is based on charge generated during the period. The third exposure signal is one of the one or more types of first signals for representing first signal value a1 corresponding to the charge converted by photoelectric converter 23 during the period of first exposure pulse A1 in the first example. The period of third exposure pulse A11 is an example of a third period, and pulse width Tp3 of third exposure pulse A11 is an example of the length of the third period.

Moreover, drive controller 30 outputs fourth exposure pulse A12 to pixel 22. By doing so, drive controller 30 exposes pixel 22 during the period of fourth exposure pulse A12 to cause pixel 22 to generate a fourth exposure signal that is based on charge generated during the period. The fourth exposure signal is another one of the one or more types of first signals for representing first signal value a1 corresponding to the charge converted by photoelectric converter 23 during the period of first exposure pulse A1 in the first example. The period of fourth exposure pulse A12 is an example of a fourth period, and pulse width Tp4 of fourth exposure pulse A12 is an example of the length of the fourth period.

Moreover, drive controller 30 outputs fifth exposure pulse A21 to pixel 22. By doing so, drive controller 30 exposes pixel 22 during the period of fifth exposure pulse A21 to cause pixel 22 to generate a fifth exposure signal that is based on charge generated during the period. The fifth exposure signal is one of the one or more types of second signals for representing second signal value a2 corresponding to the charge converted by photoelectric converter 23 during the period of second exposure pulse A2 in the first example. The period of fifth exposure pulse A21 is an example of a fifth period, and pulse width Tp5 of fifth exposure pulse A21 is an example of the length of the fifth period. Moreover, drive controller 30 outputs sixth exposure pulse A22 to pixel 22. By doing so, drive controller 30 exposes pixel 22 during the period of sixth exposure pulse A22 to cause pixel 22 to generate a sixth exposure signal that is based on charge generated during the period. The sixth exposure signal is another one of the one or more types of second signals for representing second signal value a2 corresponding to the charge converted by photoelectric converter 23 during the period of second exposure pulse A2 in the first example. The period of sixth exposure pulse A22 is an example of a sixth period, and pulse width Tp6 of sixth exposure pulse A22 is an example of the length of the sixth period.

Pulse width Tp4 of fourth exposure pulse A12 is shorter than pulse width Tp3 of third exposure pulse A11. Moreover, each of pulse width Tp3 and pulse width Tp4 is longer than pulse width Tp1 of first exposure pulse A1 in the first example. Moreover, with light emission pulse L used as a reference, the periods of third exposure pulse A11 and fourth exposure pulse A12 overlap such that the ends of the periods coincide, and the period where the periods of third exposure pulse A11 and fourth exposure pulse A12 do not overlap is the same as the period of first exposure pulse A1 in the first example. That is, when light emission pulse L is used as a reference, the difference between the periods of third exposure pulse A11 and fourth exposure pulse A12 is the period of first exposure pulse A1 illustrated in FIG. 4.

Moreover, pulse width Tp6 of sixth exposure pulse A22 is shorter than pulse width Tp5 of fifth exposure pulse A21. Moreover, each of pulse width Tp5 and pulse width Tp6 is longer than pulse width Tp2 of second exposure pulse A2 in the first example. Moreover, with light emission pulse L used as a reference, the periods of fifth exposure pulse A21 and sixth exposure pulse A22 overlap such that the ends of the periods coincide, and the period where the periods of fifth exposure pulse A21 and sixth exposure pulse A22 do not overlap is the same as the period of second exposure pulse A2 in the first example. That is, when light emission pulse L is used as a reference, the difference between the periods of fifth exposure pulse A21 and sixth exposure pulse A22 is the period of second exposure pulse A2 illustrated in FIG. 4.

Each of third exposure pulse A11, fourth exposure pulse A12, fifth exposure pulse A21, and sixth exposure pulse A22 starts at a timing referenced to light emission pulse L. In the example illustrated in FIG. 6, third exposure pulse A11 starts simultaneously with the start of light emission pulse L. Moreover, with light emission pulse L used as a reference, fourth exposure pulse A12 starts with a delay of pulse width Tp1 of first exposure pulse A1 in the first example relative to the start of third exposure pulse A11. Moreover, with light emission pulse L used as a reference, fifth exposure pulse A21 starts with a delay of pulse width TpL of light emission pulse L relative to the start of third exposure pulse A11. Moreover, with light emission pulse L used as a reference, sixth exposure pulse A22 starts with a delay of pulse width Tp2 of second exposure pulse A2 in the first example relative to the start of fifth exposure pulse A21.

Moreover, in the example illustrated in FIG. 6, pulse width Tp3 of third exposure pulse A11 and pulse width Tp5 of fifth exposure pulse A21 are equal to each other. Moreover, pulse width Tp4 of fourth exposure pulse A12 and pulse width Tp6 of sixth exposure pulse A22 are equal to each other. It should be noted that as long as the difference between pulse width Tp3 and pulse width Tp4 is pulse width Tp1, the lengths of pulse width Tp3 and pulse width Tp4 are not particularly limited. Likewise, as long as the difference between pulse width Tp5 and pulse width Tp6 is pulse width Tp2, the lengths of pulse width Tp5 and pulse width Tp6 are not particularly limited.

Distance calculator 40 calculates the distance to the target object based on the third exposure signal, fourth exposure signal, fifth exposure signal, and sixth exposure signal generated by one or more pixels 22. Specifically, the difference between the signal values of the third exposure signal and fourth exposure signal is first signal value a1 in the first example. Moreover, the difference between the signal values of the fifth exposure signal and sixth exposure signal is second signal value a2 in the first example. Moreover, the difference between pulse width Tp3 and pulse width Tp4 is pulse width Tp1 in the first example. Accordingly, distance calculator 40 can calculate distance Z to the target object, using the above Expression (1).

In the second example, the difference between the periods of third exposure pulse A11 and fourth exposure pulse A12 is the period of first exposure pulse A1. Accordingly, each of pulse width Tp3 of third exposure pulse A11 and pulse width Tp4 of fourth exposure pulse A12 can be made longer than pulse width Tp1 of first exposure pulse A1. Moreover, the difference between the periods of fifth exposure pulse A21 and sixth exposure pulse A22 is the period of second exposure pulse A2. Accordingly, each of pulse width Tp5 of fifth exposure pulse A21 and pulse width Tp6 of sixth exposure pulse A22 can be made longer than pulse width Tp2 of second exposure pulse A2. To generate an exposure pulse with a short pulse width, it is necessary to increase the size of a circuit for supplying exposure pulses to pixel 22. In the second example, as described above, since pulse width Tp3, pulse width Tp4, pulse width Tp5, and pulse width Tp6 of third exposure pulse A11, fourth exposure pulse A12, fifth exposure pulse A21, and sixth exposure pulse A22 can be made longer, it is possible to suppress an increase in the size of the circuit for supplying exposure pulses to pixel 22. Moreover, first signal value a1 and second signal value a2 as those described in the above first example can be represented using the third exposure signal, fourth exposure signal, fifth exposure signal, and sixth exposure signal. Accordingly, imaging apparatus 100 can obtain signal values with a reduced effect of multipath light MP.

It should be noted that in the second example, as long as the difference between the periods of third exposure pulse A11 and fourth exposure pulse A12 is the period of first exposure pulse A1, the periods of third exposure pulse A11 and fourth exposure pulse A12 are not particularly limited. With light emission pulse L used as a reference, the periods of third exposure pulse A11 and fourth exposure pulse A12 may overlap such that the starts of the periods coincide instead of the ends of the periods coinciding. Likewise, as long as the difference between the periods of fifth exposure pulse A21 and sixth exposure pulse A22 is the period of second exposure pulse A2, the periods of fifth exposure pulse A21 and sixth exposure pulse A22 are not particularly limited. With light emission pulse L used as a reference, the periods of fifth exposure pulse A21 and sixth exposure pulse A22 may overlap such that the starts of the periods coincide instead of the ends of the periods coinciding.

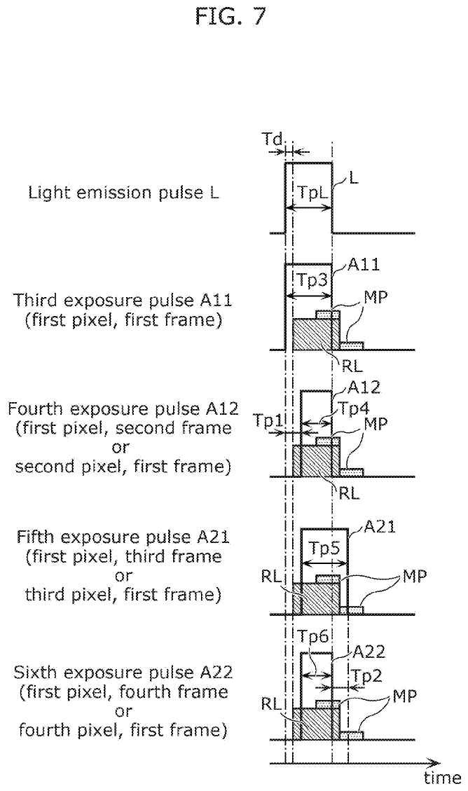

FIG. 7 is a time chart illustrating another second example of the method for driving imaging apparatus 100 according to the embodiment. Explanations for matters indicated by “Light emission pulse L”, “Third exposure pulse A11”, “Fourth exposure pulse A12”, “Fifth exposure pulse A21”, and “Sixth exposure pulse A22” in FIG. 7 are the same as in FIG. 6. The example of the driving method illustrated in FIG. 7 differs from that of the driving method illustrated in FIG. 6 in that the periods of fifth exposure pulse A21 and sixth exposure pulse A22 overlap such that the starts of the periods coincide.

As illustrated in FIG. 7, with light emission pulse L used as a reference, fifth exposure pulse A21 starts with a delay of a period shorter than pulse width TpL of light emission pulse L relative to the start of third exposure pulse A11. Moreover, with light emission pulse L used as a reference, the periods of fifth exposure pulse A21 and sixth exposure pulse A22 overlap such that the starts of the periods coincide, and the period where the periods of fifth exposure pulse A21 and sixth exposure pulse A22 do not overlap is the same as the period of second exposure pulse A2 in the first example. That is, as in the example illustrated in FIG. 6, the difference between the periods of fifth exposure pulse A21 and sixth exposure pulse A22 is the period of second exposure pulse A2.

In the example illustrated in FIG. 7, since the starts of the periods of fifth exposure pulse A21 and sixth exposure pulse A22 coincide, the ends of fifth exposure pulse A21 and sixth exposure pulse A22 are not later than the end of second exposure pulse A2 in the first example. That is, it is possible to advance the end time of the exposure of pixel 22. Accordingly, it is possible to enhance the frame rate.

### (3) Third Example of Driving Method

Next, a third example of the method for driving imaging apparatus 100 according to the embodiment is described.

Explanations for the third example below focus on the differences from the first and second examples above, and explanations for common points are omitted or simplified.

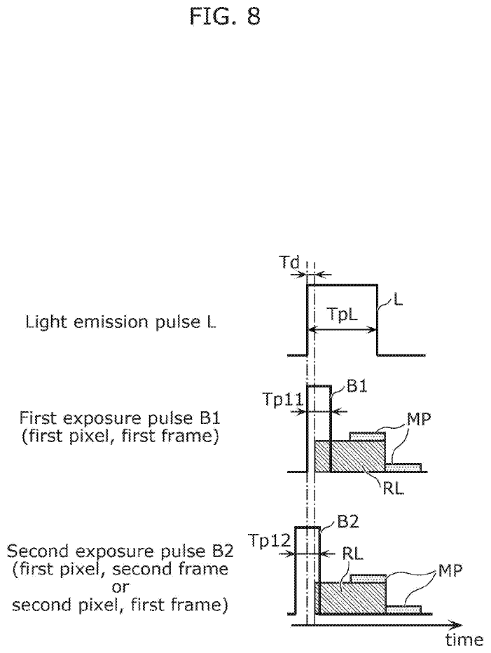

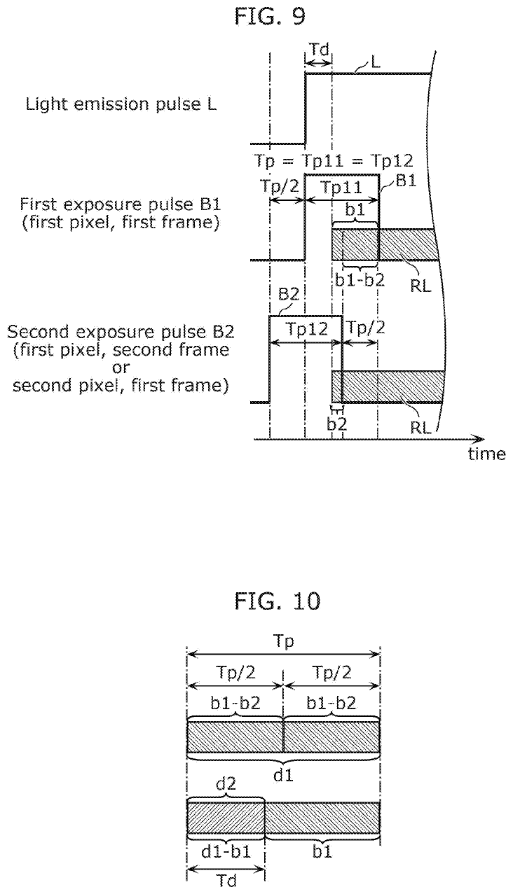

FIG. 8 is a time chart illustrating the third example of the method for driving imaging apparatus 100 according to the embodiment. FIG. 9 is an enlarged illustration of first exposure pulse B1 and second exposure pulse B2 in FIG. 8. FIG. 10 illustrates a signal value obtained in the third example of the method for driving imaging apparatus 100 according to the embodiment.

Explanations for matters indicated by “Light emission pulse L” in FIGS. 8 and 9 are the same as in FIG. 4. Moreover, matters indicated by “First exposure pulse B1” and “Second exposure pulse B2” in FIGS. 8 and 9 are explained by replacing first exposure pulse A1 and second exposure pulse A2 with first exposure pulse B1 and second exposure pulse B2, respectively in the explanations for the matters indicated by “First exposure pulse A1” and “Second exposure pulse A2” in FIG. 4.

Moreover, regarding each of “First exposure pulse B1” and “Second exposure pulse B2” in FIGS. 8 and 9, as in FIG. 4, a period when reflected light RL from the target object via a direct path, which is the pulsed light emitted from light source 10, is incident on pixel 22 is illustrated, and a period when multipath light MP is incident on pixel 22 is illustrated.

Moreover, the frames, pixels 22, and output count for first exposure pulse B1 and second exposure pulse B2 in FIGS. 8 and 9 are similar to those for first exposure pulse A1 and second exposure pulse A2 in FIG. 4.

As illustrated in FIGS. 8 and 9, drive controller 30 outputs first exposure pulse B1 to pixel 22. By doing so, drive controller 30 exposes pixel 22 during the period of first exposure pulse B1 to cause pixel 22 to generate a first exposure signal that is based on charge generated during the period. The first exposure signal is a first signal representing first signal value b1 corresponding to the charge converted by photoelectric converter 23 during the period of first exposure pulse B1. The period of first exposure pulse B1 is an example of the first period, and pulse width Tp11 of first exposure pulse B1 is an example of the length of the first period.

Moreover, drive controller 30 outputs second exposure pulse B2 to pixel 22. By doing so, drive controller 30 exposes pixel 22 during the period of second exposure pulse B2 to cause pixel 22 to generate a second exposure signal that is based on charge generated during the period. The second exposure signal is a second signal representing second signal value b2 corresponding to the charge converted by photoelectric converter 23 during the period of second exposure pulse B2. The period of second exposure pulse B2 is an example of the second period, and pulse width Tp12 of second exposure pulse B2 is an example of the length of the second period.

First exposure pulse B1 and second exposure pulse B2 differ from first exposure pulse A1 and second exposure pulse A2 in the above first example in terms of the time difference between start times. Specifically, each of first exposure pulse B1 and second exposure pulse B2 starts at a timing referenced to light emission pulse L. Pulse width Tp11 of first exposure pulse B1 and pulse width Tp12 of second exposure pulse B2 are equal to each other, and are each shorter than pulse width TpL of light emission pulse L. Hereinafter, pulse width Tp11 of first exposure pulse B1 and pulse width Tp12 of second exposure pulse B2, which are equal to each other, may be referred to as pulse width Tp. For example, pulse width Tp is less than or equal to 0.5 times pulse width TpL. Although the lower limits of pulse width Tp11 and pulse width Tp12 are not particularly limited as long as the necessary distance measurement range can be ensured, each of pulse width Tp11 and pulse width Tp12 may be at least 0.01 or 0.1 times pulse width TpL.

In the example illustrated in FIGS. 8 and 9, first exposure pulse B1 starts simultaneously with the start of light emission pulse L. Moreover, with light emission pulse L used as a reference, second exposure pulse B2 starts with a time difference of half of pulse width Tp (=Tp/2) relative to the start of first exposure pulse B1. More specifically, with light emission pulse L used as a reference, second exposure pulse B2 starts earlier than the start of first exposure pulse B1 by half of pulse width Tp. It should be noted that drive controller 30 may output one or more yet other exposure pulses to pixel 22 after first exposure pulse B1. Exposure pulses including first exposure pulse B1 and second exposure pulse B2 in this case each start with a time lag of pulse width Tp. Thus, the distance measurement range of imaging apparatus 100 can be extended.

Distance calculator 40 calculates the distance to the target object based on the first exposure signal and the second exposure signal generated by one or more pixels 22. As illustrated in FIG. 9, by subtracting second signal value b2 from first signal value b1, it is possible to obtain difference signal value b1−b2 corresponding to the light incident on pixel 22 during the period corresponding to half of pulse width Tp. Moreover, as illustrated in FIG. 10, by doubling difference signal value b1−b2, it is possible to obtain total signal value d1 corresponding to the light incident on pixel 22 during the period corresponding to pulse width Tp. Furthermore, by subtracting first signal value b1 from total signal value d1, it is possible to obtain delay signal value d2 corresponding to the light incident on pixel 22 during the period corresponding to time Td correlated with the distance to the target object. From the above, distance Z to the target object is calculated by the following Expression (2).

$$\begin{matrix}[ Math . 2 ] & \\ Z = \frac{c \times Td}{2} = \frac{c}{2} \times \frac{d 2}{d 1} Tp & ( 2 )\end{matrix}$$

In the example illustrated in FIGS. 8 and 9, each of pulse width Tp11 of first exposure pulse B1 and pulse width Tp12 of second exposure pulse B2 is shorter than pulse width TpL of light emission pulse L. Moreover, since the time difference between the starts of first exposure pulse B1 and second exposure pulse B2 is half of pulse width Tp, the periods of first exposure pulse B1 and second exposure pulse B2 overlap. Accordingly, in the example illustrated in FIGS. 8 and 9, first exposure pulse B1 and second exposure pulse B2 end by the time multipath light MP is incident on pixel 22. That is, first signal value b1 and second signal value b2 do not include components of multipath light MP. Thus, since the time difference between the starts of first exposure pulse B1 and second exposure pulse B2 is shorter than pulse width Tp, the end of exposure of pixel 22 is advanced. This makes it difficult for multipath light MP, which is incident on pixel 22 with a delay relative to reflected light RL, to be incident on pixel 22 during the exposure. Thus, it is possible to effectively reduce components of multipath light MP in first signal value b1 and second signal value b2. Accordingly, imaging apparatus 100 can obtain signal values with a reduced effect of multipath light MP. Moreover, because of the reduction in the effect of multipath light MP, imaging apparatus 100 can improve the accuracy of the distance calculated by distance calculator 40.

It should be noted that in the third example, the time difference between the starts of first exposure pulse B1 and second exposure pulse B2 is not limited to half of pulse width Tp, and is not particularly limited as long as it is shorter than pulse width Tp. In the third example, the time difference between the starts of first exposure pulse B1 and second exposure pulse B2 may be 1/N times pulse width Tp. Here, N is an integer or a decimal greater than 1. In this case, total signal value d1 described above is obtained by multiplying difference signal value b1-b2 by N. N may be greater than or equal to 2 in terms of extending the distance measurement range. That is, the time difference between the starts of first exposure pulse B1 and second exposure pulse B2 may be half of pulse width Tp or less. Moreover, N may be 4 or less in terms of the accuracy of distance measurement.

Moreover, as a non-limiting example, FIGS. 8 and 9 illustrate that first exposure pulse B1 starts simultaneously with the start of light emission pulse L. As with the example illustrated in FIG. 5, first exposure pulse B1 may start with a delay relative to the start of light emission pulse L without changing the time difference between the starts of first exposure pulse B1 and second exposure pulse B2.

### (4) Fourth Example of Driving Method

Next, a fourth example of the method for driving imaging apparatus 100 according to the embodiment is described. Explanations for the fourth example below focus on the differences from the first to third examples above, and explanations for common points are omitted or simplified.

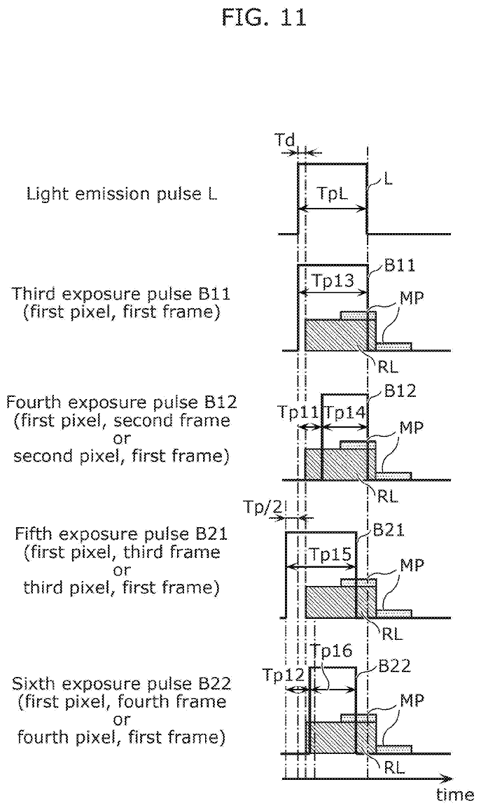

FIG. 11 is a time chart illustrating the fourth example of the method for driving imaging apparatus 100 according to the embodiment. Explanations for matters indicated by “Light emission pulse L” in FIG. 11 are the same as in FIG. 4. Moreover, matters indicated by “Third exposure pulse B11”, “Fourth exposure pulse B12”, “Fifth exposure pulse B21”, and “Sixth exposure pulse B22” in FIG. 11 are explained by replacing third exposure pulse A11, fourth exposure pulse A12, fifth exposure pulse A21, and sixth exposure pulse A22 with third exposure pulse B11, fourth exposure pulse B12, fifth exposure pulse B21, and sixth exposure pulse B22, respectively in the explanations for the matters indicated by “Third exposure pulse A11”, “Fourth exposure pulse A12”, “Fifth exposure pulse A21”, and “Sixth exposure pulse A22” in FIG. 8.

Moreover, regarding each of “Third exposure pulse B11”, “Fourth exposure pulse B12”, “Fifth exposure pulse B21”, and “Sixth exposure pulse B22” in FIG. 11, as in FIG. 4, a period when reflected light RL from the target object via a direct path, which is the pulsed light emitted from light source 10, is incident on pixel 22 is illustrated, and a period when multipath light MP is incident on pixel 22 is illustrated.

Moreover, the frames, pixels 22, and output count for third exposure pulse B11, fourth exposure pulse B12, fifth exposure pulse B21, and sixth exposure pulse B22 in FIG. 11 are similar to those for third exposure pulse A11, fourth exposure pulse A12, fifth exposure pulse A21, and sixth exposure pulse A22 in FIG. 6.

As illustrated in FIG. 11, drive controller 30 outputs third exposure pulse B11 to pixel 22. By doing so, drive controller 30 exposes pixel 22 during the period of third exposure pulse B11 to cause pixel 22 to generate a third exposure signal that is based on charge generated during the period. The third exposure signal is one of the one or more types of first signals for representing first signal value b1 corresponding to the charge converted by photoelectric converter 23 during the period of first exposure pulse B1 in the third example. The period of third exposure pulse B11 is an example of the third period, and pulse width Tp13 of third exposure pulse B11 is an example of the length of the third period.

Moreover, drive controller 30 outputs fourth exposure pulse B12 to pixel 22. By doing so, drive controller 30 exposes pixel 22 during the period of fourth exposure pulse B12 to cause pixel 22 to generate a fourth exposure signal that is based on charge generated during the period. The fourth exposure signal is another one of the one or more types of first signals for representing first signal value b1 corresponding to the charge converted by photoelectric converter 23 during the period of first exposure pulse B1 in the third example. The period of fourth exposure pulse B12 is an example of the fourth period, and pulse width Tp14 of fourth exposure pulse B12 is an example of the length of the fourth period.

Moreover, drive controller 30 outputs fifth exposure pulse B21 to pixel 22. By doing so, drive controller 30 exposes pixel 22 during the period of fifth exposure pulse B21 to cause pixel 22 to generate a fifth exposure signal that is based on charge generated during the period. The fifth exposure signal is one of the one or more types of second signals for representing second signal value b2 corresponding to the charge converted by photoelectric converter 23 during the period of second exposure pulse B2 in the third example. The period of fifth exposure pulse B21 is an example of the fifth period, and pulse width Tp15 of fifth exposure pulse B21 is an example of the length of the fifth period.

Moreover, drive controller 30 outputs sixth exposure pulse B22 to pixel 22. By doing so, drive controller 30 exposes pixel 22 during the period of sixth exposure pulse B22 to cause pixel 22 to generate a sixth exposure signal that is based on charge generated during the period. The sixth exposure signal is another one of the one or more types of second signals for representing second signal value b2 corresponding to the charge converted by photoelectric converter 23 during the period of second exposure pulse B2 in the third example. The period of sixth exposure pulse B22 is an example of the sixth period, and pulse width Tp16 of sixth exposure pulse B22 is an example of the length of the sixth period.

Pulse width Tp14 of fourth exposure pulse B12 is shorter than pulse width Tp13 of third exposure pulse B11. Moreover, each of pulse width Tp13 and pulse width Tp14 is longer than pulse width Tp11 of first exposure pulse B1 in the third example. Moreover, with light emission pulse L used as a reference, the periods of third exposure pulse B11 and fourth exposure pulse B12 overlap such that the ends of the periods coincide, and the period where the periods of third exposure pulse B11 and fourth exposure pulse B12 do not overlap is the same as the period of first exposure pulse B1 in the third example. That is, when light emission pulse L is used as a reference, the difference between the periods of third exposure pulse B11 and fourth exposure pulse B12 is the period of first exposure pulse B1 illustrated in FIG. 8.

Moreover, pulse width Tp16 of sixth exposure pulse B22 is shorter than pulse width Tp15 of fifth exposure pulse B21. Moreover, each of pulse width Tp15 and pulse width Tp16 is longer than pulse width Tp12 of second exposure pulse B2 in the third example. Moreover, with light emission pulse L used as a reference, the periods of fifth exposure pulse B21 and sixth exposure pulse B22 overlap such that the ends of the periods coincide, and the period where the periods of fifth exposure pulse B21 and sixth exposure pulse B22 do not overlap is the same as the period of second exposure pulse B2 in the third example. That is, when light emission pulse L is used as a reference, the difference between the periods of fifth exposure pulse B21 and sixth exposure pulse B22 is the period of second exposure pulse B2 illustrated in FIG. 8.

Each of third exposure pulse B11, fourth exposure pulse B12, fifth exposure pulse B21, and sixth exposure pulse B22 starts at a timing referenced to light emission pulse L. In the example illustrated in FIG. 11, third exposure pulse B11 starts simultaneously with the start of light emission pulse L. Moreover, with light emission pulse L used as a reference, fourth exposure pulse B12 starts with a delay of pulse width Tp11 of first exposure pulse B1 in the third example relative to the start of third exposure pulse B11. Moreover, with light emission pulse L used as a reference, fifth exposure pulse B21 starts earlier than the start of third exposure pulse B11 by half of pulse width Tp (=Tp/2). Moreover, with light emission pulse L used as a reference, sixth exposure pulse B22 starts with a delay of pulse width Tp12 of second exposure pulse B2 in the third example relative to the start of fifth exposure pulse B21.

Moreover, in the example illustrated in FIG. 11, pulse width Tp13 of third exposure pulse B11 and pulse width Tp15 of fifth exposure pulse B21 are equal to each other. Moreover, pulse width Tp14 of fourth exposure pulse B12 and pulse width Tp16 of sixth exposure pulse B22 are equal to each other. It should be noted that as long as the difference between pulse width Tp13 and pulse width Tp14 is pulse width Tp11, the lengths of pulse width Tp13 and pulse width Tp14 are not particularly limited. Likewise, as long as the difference between pulse width Tp15 and pulse width Tp16 is pulse width Tp12, the lengths of pulse width Tp15 and pulse width Tp16 are not particularly limited.

Distance calculator 40 calculates the distance to the target object based on the third exposure signal, fourth exposure signal, fifth exposure signal, and sixth exposure signal generated by one or more pixels 22. Specifically, the difference between the signal values of the third exposure signal and fourth exposure signal is first signal value b1 in the third example. Moreover, the difference between the signal values of the fifth exposure signal and sixth exposure signal is second signal value b2 in the third example. Moreover, the difference between pulse width Tp13 and pulse width Tp14 is pulse width Tp11 in the third example (in other words, pulse width Tp). Accordingly, by calculating total signal value d1 and delay signal value d2 from first signal value b1 and second signal value b2 as in the above third example, distance calculator 40 can calculate distance Z to the target object, using the above Expression (2).

In the fourth example, the difference between the periods of third exposure pulse B11 and fourth exposure pulse B12 is the period of first exposure pulse B1. Accordingly, each of pulse width Tp13 of third exposure pulse B11 and pulse width Tp14 of fourth exposure pulse B12 can be made longer than pulse width Tp11 of first exposure pulse B1. Moreover, the difference between the periods of fifth exposure pulse B21 and sixth exposure pulse B22 is the period of second exposure pulse B2. Accordingly, each of pulse width Tp15 of fifth exposure pulse B21 and pulse width Tp16 of sixth exposure pulse B22 can be made longer than pulse width Tp12 of second exposure pulse B2. To generate an exposure pulse with a shorter pulse width, it is necessary to increase the size of a circuit for supplying exposure pulses to pixel 22. In the fourth example, as described above, since pulse width Tp13, pulse width Tp14, pulse width Tp15, and pulse width Tp16 of third exposure pulse B11, fourth exposure pulse B12, fifth exposure pulse B21, and sixth exposure pulse B22 can be made longer, it is possible to suppress an increase in the size of the circuit for supplying exposure pulses to pixel 22. Moreover, since first signal value b1 and second signal value b2 as those described in the above third example can be represented using the third exposure signal, fourth exposure signal, fifth exposure signal, and sixth exposure signal, imaging apparatus 100 can obtain signal values with a reduced effect of multipath light MP.

It should be noted that in the fourth example, as long as the difference between the periods of third exposure pulse B11 and fourth exposure pulse B12 is the period of first exposure pulse B1, the periods of third exposure pulse B11 and fourth exposure pulse B12 are not particularly limited. With light emission pulse L used as a reference, the periods of third exposure pulse B11 and fourth exposure pulse B12 may overlap such that the starts of the periods coincide instead of the ends of the periods coinciding. Likewise, as long as the difference between the periods of fifth exposure pulse B21 and sixth exposure pulse B22 is the period of second exposure pulse B2, the periods of fifth exposure pulse B21 and sixth exposure pulse B22 are not particularly limited. With light emission pulse L used as a reference, the periods of fifth exposure pulse B21 and sixth exposure pulse B22 may overlap such that the starts of the periods coincide instead of the ends of the periods coinciding.

### Variations

Next, a variation of the embodiment is described. In the variation described below, an imaging apparatus that performs the second or fourth example of the driving method described above is described. Moreover, explanations for the variation below focus on the differences from the embodiment, and explanations for common points are omitted or simplified.

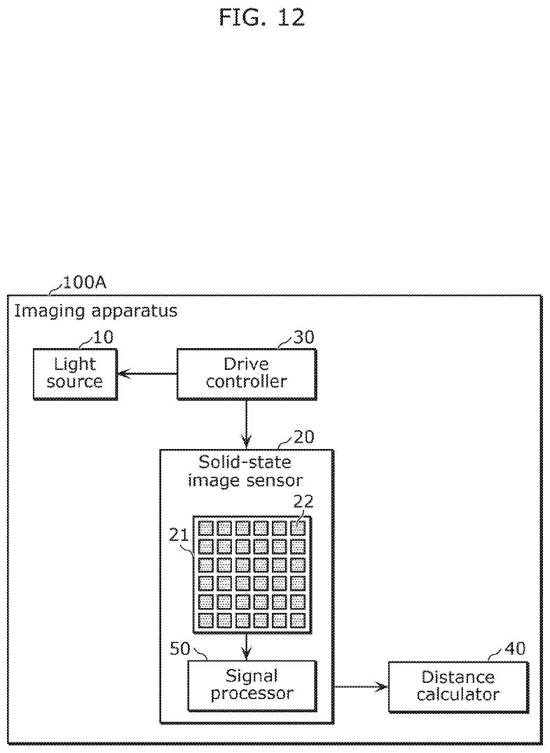

FIG. 12 is a functional block diagram illustrating an example of a configuration of imaging apparatus 100A according to the variation. As illustrated in FIG. 12, imaging apparatus 100A according to the variation mainly differs from imaging apparatus 100 according to the embodiment in that it further includes signal processor 50.

In the example illustrated in FIG. 12, signal processor 50 is provided inside solid-state image sensor 20. It should be noted that signal processor 50 may be provided outside solid-state image sensor 20.

Signal processor 50 generates a first difference signal representing first signal value a1 or first signal value b1, based on the difference between the third exposure signal and the fourth exposure signal described above. For instance, signal processor 50 generates a first difference signal by subtracting an analog-to-digital (A/D) converted fourth exposure signal from an A/D converted third exposure signal. Moreover, signal processor 50 generates a second difference signal representing second signal value a2 or second signal value b2, based on the difference between the fifth exposure signal and the sixth exposure signal described above. For instance, signal processor 50 generates a second difference signal by subtracting an A/D converted sixth exposure signal from an A/D converted fifth exposure signal. Signal processor 50 outputs the generated first difference signal and second difference signal to distance calculator 40. It should be noted that signal processor 50 may generate the first difference signal and the second difference signal using analog signals prior to A/D conversion.

Signal processor 50 is, for example, a processing circuit implemented by memory storing a program, a processor that executes the program, and so forth. Moreover, signal processor 50 may be an analog circuit, or a dedicated logic circuit for performing predetermined processing. It should be noted that all or part of drive controller 30, distance calculator 40, and signal processor 50 may be configured using the same memory and the same processor.

### Others

Although the imaging apparatus and the method for driving the imaging apparatus according to one or more aspects of the present disclosure are described above based on the embodiment and the variation, the present disclosure is not limited to the embodiment. The one or more aspects of the present disclosure may encompass embodiments obtained by adding various modifications envisioned by those skilled in the art to each embodiment and embodiments created by combining elements from different embodiments and the variation, provided that these embodiments are within the scope of the present disclosure.

For instance, in the above embodiment and variation, as a non-limiting example, imaging apparatus 100 and imaging apparatus 100A each include light source 10. Imaging apparatus 100 and imaging apparatus 100A need not include light source 10 and may use an external light source. In this case, a light emission control signal may be output from drive controller 30 to the external light source, and a light emission control signal may be output from an external controller to the external light source.

Moreover, for instance, in the above embodiment and variation, as a non-limiting example, imaging apparatus 100 and imaging apparatus 100A each include distance calculator 40. Imaging apparatus 100 and imaging apparatus 100A need not include distance calculator 40 and may be apparatuses that output a signal for calculating the distance to a target object.

Moreover, for instance, in the embodiment and variation described above, as a non-limiting example, the exposure period of pixel 22 is determined by applying each exposure pulse to the gate of transfer transistor 24 as transfer control signal TG. As long as, during the exposure period, pixel 22 can output a signal based on charge converted by photoelectric converter 23, driving of pixel 22 for determining the exposure period is not particularly limited. For instance, the exposure period of pixel 22 may start when charge drain transistor 26 switches from ON to OFF, with transfer transistor 24 remaining in an OFF state. In this case, transfer transistor 24 switches from OFF to ON after the start of the exposure period, and transfer transistor 24 is turned off again, leading to the end of the exposure period of pixel 22.

Moreover, in the embodiment and variation described above, each element may be implemented by executing a software program suitable for the element. Each element may be implemented by a program executer, such as a processor, reading out and executing the software program stored in a recording medium, such as a hard disk or semiconductor memory.

Moreover, each element may be implemented as hardware. Each element may be a circuit (or an integrated circuit). These circuits may collectively form a signal circuit, or may be separate circuits. Moreover, these circuits may be general-purpose circuits or dedicated circuits.

Moreover, a general or specific aspect of the present disclosure may be implemented as a system, a device, a method, an integrated circuit, a computer program, a computer program product, or a computer-readable recording medium, such as a CD-ROM. Moreover, a general or specific aspect of the present disclosure may be implemented as any combination of the system, device, method, integrated circuit, computer program, computer program product, and recording medium.

For instance, the present disclosure may be implemented as the imaging apparatus according to the embodiment or the variation described above, a control apparatus that controls the imaging apparatus, a method for driving the imaging apparatus, which includes steps (processing) described as an operation of the imaging apparatus described above, a program for causing a computer to execute such a method for driving the imaging apparatus, and a non-transitory computer-readable recording medium having recorded thereon such a program.

Hereinafter, examples of the imaging apparatus and the method for driving the imaging apparatus according to the present disclosure, which are described based on embodiment and variation above, are described. The imaging apparatus and the method for driving the imaging apparatus according to the present disclosure are not limited to the examples below.

For instance, an imaging apparatus according to a first aspect of the present disclosure includes: a plurality of pixels arranged in a matrix, the plurality of pixels each including a photoelectric converter that converts incident light into charge, and generating a signal based on the charge; and a drive controller that exposes, in each of one or more frames, each of the plurality of pixels at a timing referenced to emission of pulsed light from a light source toward a target object, in which the drive controller exposes the plurality of pixels to cause the plurality of pixels to generate one or more types of first signals and one or more types of second signals, the one or more types of first signals being for representing a first signal value corresponding to the charge converted by the photoelectric converter during a first period that starts at a timing referenced to the emission of the pulsed light from the light source, the one or more types of second signals being for representing a second signal value corresponding to the charge converted by the photoelectric converter during a second period that starts at a timing referenced to the emission of the pulsed light from the light source, the second period starts with a predetermined time difference relative to a start of the first period, with the emission of the pulsed light from the light source used as a reference, and a length of the first period and a length of the second period are equal to each other, and are each shorter than a pulse width of the pulsed light.

Thus, the plurality of pixels generate the one or more types of first signals for representing the first signal value corresponding to the charge generated during the first period and the one or more types of second signals for representing the second signal value corresponding to the charge generated during the second period. Here, each of the lengths of the first period and the second period is shorter than the pulse width of the pulsed light. This makes it possible to reduce the charge generated based on multipath light during the first period and the second period, which, in turn, can reduce multipath light components in the first signal value and the second signal value. Accordingly, the imaging apparatus according to the first aspect can obtain a signal value with a reduced effect of multipath light.

Moreover, an imaging apparatus according to a second aspect of the present disclosure is the imaging apparatus according to the first aspect, in which the predetermined time difference is equal to the pulse width of the pulsed light.

Thus, the ratio of the first signal value to the second signal value is a ratio corresponding to a delay time of reflected light incident on a pixel relative to the emission of pulsed light from the light source. Accordingly, it is possible to calculate the distance to the target object from the ratio of the first signal value to the second signal value, which can simplify computation necessary to calculate the distance to the target object.

Moreover, for instance, an imaging apparatus according to a third aspect of the present disclosure is the imaging apparatus according to the first aspect, in which the predetermined time difference is shorter than each of the length of the first period and the length of the second period.

Thus, the first period and the second period overlap. As such, with the emission of pulsed light from the light source used as a reference, periods to both ends of the first period and the second period are shortened, which makes it difficult for multipath light that is incident on the pixel with a delay relative to the reflected light to be incident on the pixel during the first period and the second period. Accordingly, it is possible to further reduce the multipath light components in the first signal value and the second signal value.

Moreover, for instance, an imaging apparatus according to a fourth aspect of the present disclosure is the imaging apparatus according to the third aspect, in which the predetermined time difference is half or less of each of the length of the first period and the length of the second period.

This can extend the distance measurement range.

Moreover, for instance, an imaging apparatus according to a fifth aspect of the present disclosure is the imaging apparatus according to any one of the first to fourth aspects, in which the drive controller: exposes each of one or more pixels among the plurality of pixels during the first period to cause each of the one or more pixels to generate a first exposure signal as the one or more types of first signals; and exposes each of one or more pixels among the plurality of pixels during the second period to cause each of the one or more pixels to generate a second exposure signal as the one or more types of second signals.

Thus, the first exposure signal can be used directly as a signal representing the first signal value. Moreover, the second exposure signal can be used directly as a signal representing the second signal value. Accordingly, it is possible to simplify computation necessary to calculate the distance to the target object.

Moreover, for instance, an imaging apparatus according to a sixth aspect of the present disclosure is the imaging apparatus according to the fifth aspect, in which the plurality of pixels include a first pixel, in a first frame, the drive controller exposes the first pixel during the first period to cause the first pixel to generate the first exposure signal, and in a second frame, the drive controller exposes the first pixel during the second period to cause the first pixel to generate the second exposure signal.

This enables the pixel to generate the first exposure signal and the second exposure signal without decreasing the resolution.

Moreover, for instance, an imaging apparatus according to a seventh aspect of the present disclosure is the imaging apparatus according to the fifth aspect, in which the plurality of pixels include a first pixel and a second pixel, and in a same frame, the drive controller: exposes the first pixel during the first period to cause the first pixel to generate the first exposure signal; and exposes the second pixel during the second period to cause the second pixel to generate the second exposure signal.

Thus, it is possible to shorten the time taken for the pixel to generate the first exposure signal and the second exposure signal.

Moreover, for instance, an imaging apparatus according to an eighth aspect of the present disclosure is the imaging apparatus according to any one of the first to fourth aspects, in which the drive controller: exposes each of one or more pixels among the plurality of pixels during a third period to cause each of the one or more pixels to generate a third exposure signal as one of the one or more types of first signals, the third period starting at a timing referenced to the emission of the pulsed light from the light source; exposes each of one or more pixels among the plurality of pixels during a fourth period to cause each of the one or more pixels to generate a fourth exposure signal as another one of the one or more types of first signals, the fourth period being shorter than the third period and starting at a timing referenced to the emission of the pulsed light from the light source; exposes each of one or more pixels among the plurality of pixels during a fifth period to cause each of the one or more pixels to generate a fifth exposure signal as one of the one or more types of second signals, the fifth period starting at a timing referenced to the emission of the pulsed light from the light source; and exposes each of one or more pixels among the plurality of pixels during a sixth period to cause each of the one or more pixels to generate a sixth exposure signal as another one of the one or more types of second signals, the sixth period being shorter than the fifth period and starting at a timing referenced to the emission of the pulsed light from the light source, and when the emission of the pulsed light from the light source is used as a reference, the third period and the fourth period overlap with one of starts or ends of the third period and the fourth period coinciding, and a period where the third period and the fourth period do not overlap is same as the first period, and the fifth period and the sixth period overlap with one of starts or ends of the fifth period and the sixth period coinciding, and a period where the fifth period and the sixth period do not overlap is same as the second period.

Thus, it is possible to extend the pixel exposure period than the first period and the second period. To generate a signal that instructs the pixel to perform a short-duration exposure, it is necessary to increase the size of a circuit for supplying the signal to the pixel. In the eighth aspect, since a pixel exposure period can be extended, it is possible to increase the circuit size. Moreover, for instance, an imaging apparatus according to a ninth aspect of the present disclosure is the imaging apparatus according to the eighth aspect, in which the plurality of pixels include a first pixel, in a first frame, the drive controller exposes the first pixel during the third period to cause the first pixel to generate the third exposure signal, in a second frame, the drive controller exposes the first pixel during the fourth period to cause the first pixel to generate the fourth exposure signal, in a third frame, the drive controller exposes the first pixel during the fifth period to cause the first pixel to generate the fifth exposure signal, and in a fourth frame, the drive controller exposes the first pixel during the sixth period to cause the first pixel to generate the sixth exposure signal.

This enables the pixel to generate the third exposure signal, the fourth exposure signal, the fifth exposure signal, and the sixth exposure signal without decreasing the resolution.

Moreover, for instance, an imaging apparatus according to a tenth aspect of the present disclosure is the imaging apparatus according to the eighth aspect, in which the plurality of pixels include a first pixel, a second pixel, a third pixel, and a fourth pixel, and in a same frame, the drive controller: exposes the first pixel during the third period to cause the first pixel to generate the third exposure signal; exposes the second pixel during the fourth period to cause the second pixel to generate the fourth exposure signal; exposes the third pixel during the fifth period to cause the third pixel to generate the fifth exposure signal; and exposes the fourth pixel during the sixth period to cause the fourth pixel to generate the sixth exposure signal.

Thus, it is possible to shorten the time taken for the pixels to generate the third exposure signal, the fourth exposure signal, the fifth exposure signal, and the sixth exposure signal.

Moreover, for instance, an imaging apparatus according to an eleventh aspect of the present disclosure is the imaging apparatus according to any one of the eighth to tenth aspects, further including: a signal processor that generates a first difference signal based on a difference between the third exposure signal and the fourth exposure signal, and generates a second difference signal based on a difference between the fifth exposure signal and the sixth exposure signal, the first difference signal representing the first signal value, the second difference signal representing the second signal value.

Thus, it is possible to use the first difference signal and the second difference signal for computation of the distance to the target object.

Moreover, for instance, an imaging apparatus according to a twelfth aspect of the present disclosure is the imaging apparatus according to any one of the first to eleventh aspects, further including: a distance calculator that calculates a distance to the target object based on the one or more types of first signals and the one or more types of second signals.

Thus, the imaging apparatus can output the distance to the target object.

Moreover, for instance, a driving method according to a thirteenth aspect of the present disclosure is a method for driving an imaging apparatus that includes a plurality of pixels arranged in a matrix, the plurality of pixels each including a photoelectric converter that converts incident light into charge, and generating a signal based on the charge. The method includes: exposing, in each of one or more frames, each of the plurality of pixels at a timing referenced to emission of pulsed light from a light source toward a target object, in which in the exposing of each of the plurality of pixels, the plurality of pixels are exposed to cause the plurality of pixels to generate one or more types of first signals and one or more types of second signals, the one or more types of first signals being for representing a first signal value corresponding to the charge converted by the photoelectric converter during a first period that starts at a timing referenced to the emission of the pulsed light from the light source, the one or more types of second signals being for representing a second signal value corresponding to the charge converted by the photoelectric converter during a second period that starts at a timing referenced to the emission of the pulsed light from the light source, the second period starts with a predetermined time difference relative to a start of the first period, and a length of the first period and a length of the second period are equal to each other, and are each shorter than a pulse width of the pulsed light.

Thus, the driving method according to the thirteenth aspect can obtain a signal value with a reduced effect of multipath light, as with the imaging apparatus according to the first aspect.

Although only an exemplary embodiment of the present disclosure has been described in detail above, those skilled in the art will readily appreciate that many modifications are possible in the exemplary embodiment without materially departing from the novel teachings and advantages of the present disclosure. Accordingly, all such modifications are intended to be included within the scope of the present disclosure.

### INDUSTRIAL APPLICABILITY

The present disclosure is usable as an imaging apparatus for obtaining a distance image of a target object, and can be used in various applications, such as an endoscopy system.

1. An imaging apparatus comprising:
a plurality of pixels arranged in a matrix, the plurality of pixels each including a photoelectric converter that converts incident light into charge, and generating a signal based on the charge; and
a drive controller that exposes, in each of one or more frames, each of the plurality of pixels at a timing referenced to emission of pulsed light from a light source toward a target object, wherein
the drive controller exposes the plurality of pixels to cause the plurality of pixels to generate one or more types of first signals and one or more types of second signals, the one or more types of first signals being for representing a first signal value corresponding to the charge converted by the photoelectric converter during a first period that starts at a timing referenced to the emission of the pulsed light from the light source, the one or more types of second signals being for representing a second signal value corresponding to the charge converted by the photoelectric converter during a second period that starts at a timing referenced to the emission of the pulsed light from the light source,
the second period starts with a predetermined time difference relative to a start of the first period, with the emission of the pulsed light from the light source used as a reference, and
a length of the first period and a length of the second period are equal to each other, and are each shorter than a pulse width of the pulsed light.

2. The imaging apparatus according to claim 1, wherein
the predetermined time difference is equal to the pulse width of the pulsed light.

3. The imaging apparatus according to claim 1, wherein
the predetermined time difference is shorter than each of the length of the first period and the length of the second period.

4. The imaging apparatus according to claim 3, wherein
the predetermined time difference is half or less of each of the length of the first period and the length of the second period.

5. The imaging apparatus according to claim 1, wherein
the drive controller:
exposes each of one or more pixels among the plurality of pixels during the first period to cause each of the one or more pixels to generate a first exposure signal as the one or more types of first signals; and
exposes each of one or more pixels among the plurality of pixels during the second period to cause each of the one or more pixels to generate a second exposure signal as the one or more types of second signals.

6. The imaging apparatus according to claim 5, wherein
the plurality of pixels include a first pixel,
in a first frame, the drive controller exposes the first pixel during the first period to cause the first pixel to generate the first exposure signal, and
in a second frame, the drive controller exposes the first pixel during the second period to cause the first pixel to generate the second exposure signal.

7. The imaging apparatus according to claim 5, wherein
the plurality of pixels include a first pixel and a second pixel, and
in a same frame, the drive controller:
exposes the first pixel during the first period to cause the first pixel to generate the first exposure signal; and
exposes the second pixel during the second period to cause the second pixel to generate the second exposure signal.

8. The imaging apparatus according to claim 1, wherein
the drive controller:
exposes each of one or more pixels among the plurality of pixels during a third period to cause each of the one or more pixels to generate a third exposure signal as one of the one or more types of first signals, the third period starting at a timing referenced to the emission of the pulsed light from the light source;
exposes each of one or more pixels among the plurality of pixels during a fourth period to cause each of the one or more pixels to generate a fourth exposure signal as another one of the one or more types of first signals, the fourth period being shorter than the third period and starting at a timing referenced to the emission of the pulsed light from the light source;
exposes each of one or more pixels among the plurality of pixels during a fifth period to cause each of the one or more pixels to generate a fifth exposure signal as one of the one or more types of second signals, the fifth period starting at a timing referenced to the emission of the pulsed light from the light source; and
exposes each of one or more pixels among the plurality of pixels during a sixth period to cause each of the one or more pixels to generate a sixth exposure signal as another one of the one or more types of second signals, the sixth period being shorter than the fifth period and starting at a timing referenced to the emission of the pulsed light from the light source, and
when the emission of the pulsed light from the light source is used as a reference,
the third period and the fourth period overlap with one of starts or ends of the third period and the fourth period coinciding, and a period where the third period and the fourth period do not overlap is same as the first period, and
the fifth period and the sixth period overlap with one of starts or ends of the fifth period and the sixth period coinciding, and a period where the fifth period and the sixth period do not overlap is same as the second period.

9. The imaging apparatus according to claim 8, wherein
the plurality of pixels include a first pixel,
in a first frame, the drive controller exposes the first pixel during the third period to cause the first pixel to generate the third exposure signal,
in a second frame, the drive controller exposes the first pixel during the fourth period to cause the first pixel to generate the fourth exposure signal,
in a third frame, the drive controller exposes the first pixel during the fifth period to cause the first pixel to generate the fifth exposure signal, and
in a fourth frame, the drive controller exposes the first pixel during the sixth period to cause the first pixel to generate the sixth exposure signal.

10. The imaging apparatus according to claim 8, wherein
the plurality of pixels include a first pixel, a second pixel, a third pixel, and a fourth pixel, and
in a same frame, the drive controller:
exposes the first pixel during the third period to cause the first pixel to generate the third exposure signal;
exposes the second pixel during the fourth period to cause the second pixel to generate the fourth exposure signal;
exposes the third pixel during the fifth period to cause the third pixel to generate the fifth exposure signal; and
exposes the fourth pixel during the sixth period to cause the fourth pixel to generate the sixth exposure signal.

11. The imaging apparatus according to claim 8, further comprising:
a signal processor that generates a first difference signal based on a difference between the third exposure signal and the fourth exposure signal, and generates a second difference signal based on a difference between the fifth exposure signal and the sixth exposure signal, the first difference signal representing the first signal value, the second difference signal representing the second signal value.

12. The imaging apparatus according to claim 1, further comprising:
a distance calculator that calculates a distance to the target object based on the one or more types of first signals and the one or more types of second signals.

13. A method for driving an imaging apparatus that includes a plurality of pixels arranged in a matrix, the plurality of pixels each including a photoelectric converter that converts incident light into charge, and generating a signal based on the charge, the method comprising:
exposing, in each of one or more frames, each of the plurality of pixels at a timing referenced to emission of pulsed light from a light source toward a target object, wherein
in the exposing of each of the plurality of pixels, the plurality of pixels are exposed to cause the plurality of pixels to generate one or more types of first signals and one or more types of second signals, the one or more types of first signals being for representing a first signal value corresponding to the charge converted by the photoelectric converter during a first period that starts at a timing referenced to the emission of the pulsed light from the light source, the one or more types of second signals being for representing a second signal value corresponding to the charge converted by the photoelectric converter during a second period that starts at a timing referenced to the emission of the pulsed light from the light source,
the second period starts with a predetermined time difference relative to a start of the first period, and
a length of the first period and a length of the second period are equal to each other, and are each shorter than a pulse width of the pulsed light.
